(19) United States
(12) Patent Application Publication
(10) Pub. No.: US 2022/0386613 A1
(43) Pub. Date: Dec. 8, 2022

(54) WEED CONTROL METHOD AND MIXED AGROCHEMICAL COMPOSITION FOR SOIL TREATMENT

(71) Applicant: KUMIAI CHEMICAL INDUSTRY CO., LTD., Tokyo (JP)

(72) Inventor: Takaya SUZUKI, Tokyo (JP)

(73) Assignee: KUMIAI CHEMICAL INDUSTRY CO., LTD., Tokyo (JP)

(21) Appl. No.: 17/771,154

(22) PCT Filed: Oct. 21, 2020
(86) PCT No.: PCT/JP2020/039628

§ 371 Date: Apr. 22, 2022

(30) Foreign Application Priority Data
Oct. 31, 2019 (JP) 2019-198617

(51) Int. Cl. A01N 43/80; A01N 43/54; A01N 43/84; A01N 25/28

(52) U.S. Cl. CPC A01N 43/80; A01N 43/54; A01N 43/84; A01N 25/28

(57) ABSTRACT

The present invention is aimed at providing a weed control method and a mixed agrochemical composition for soil treatment, which, in a soil treatment of farmland with pyroxasulfone, not only can inhibit or reduce crop injury caused by absorption into cultivated crops, without being influenced by heavy rainfall, soil type, seeding depth and the like, but also are effective against a wide range of weed species. The weed control method includes a soil treatment step of performing a soil treatment on farmland with an agrochemical composition for soil treatment, which contains pyroxasulfone, and with a protoporphyrinogen oxidase inhibitor, simultaneously or sequentially, the method being characterized in that the agrochemical composition for soil treatment further contains a masking substance that masks the pyroxasulfone, and the pyroxasulfone is microencapsulated in or coated with the masking substance. The mixed agrochemical composition for soil treatment is characterized by containing the agrochemical composition for soil treatment and a protoporphyrinogen oxidase inhibitor.

### TECHNICAL FIELD

The present invention relates to a weed control method and a mixed agrochemical composition for soil treatment, which, in a soil treatment of farmland with pyroxasulfone, not only can inhibit or reduce crop injury caused by absorption into cultivated crops, without being influenced by heavy rainfall, soil type, seeding depth and the like, but also are effective against a wide range of weed species.

### BACKGROUND ART

It is known that pyroxasulfone shows a high level of herbicidal effect on weeds of the family Poaceae [e.g., barnyard grass (Echinochloa crus-galli var. crus-galli), southern crabgrass (Digitaria ciliaris), green foxtail (Setaria viridis), annual bluegrass (Poa annua L.), Johnson grass (Sorghum halepense), orange foxtail (Alopecurus aequalis), Italian ryegrass (Lolium multiflorum Lam.), rigid ryegrass (Lolium rigidum Gaud.), common wild oat (Avena fatua L.), slough grass (Beckmannia syzigachne), and oat (Avena sativa L.)], weeds of the family Amaranthaceae, broadleaf weeds [e.g., curlytop knotweed (Persicaria lapathifolia), white goosefoot (Chenopodium album L.), starwort (Stellaria media L.), velvet leaf (Abutilon avicennae), prickly mallow (Sida spinosa L.), bigpod sesbania (Sesbaniaherbacea (Mill.) McVaugh), ragweed (Ambrosia artemisiifolia L.), morning glory (Ipomoea nil L.), stickwilly (Galium spurium var. Echinospermon), birdeye speedwell (Veronica persica), ivy-leaved speedwell (Veronica hederifolia L.), common henbit (Lamium amplexicaule L.), and violet (Viola mandshurica)] and perennial and annual weeds of the family Cyperaceae [e.g., Coco-grass (Cyperus rotundus L.), Yellow nutsedge (Cyperus esculentus L.), shortleaf spikesedge (Kyllinga brevifolia), Asian flatsedge (Cyperus microiria Steud.), and rice flat sedge (Cyperus iria L.)], and has a broad herbicidal spectrum.

Generally, a soil treatment, which is one of the effective treatment methods for an agrochemical composition on farmland, is expected to be able to control pests over an extended period; however, it is known that, due to a long period of contact with cultivated crops, a soil treatment has a higher risk of causing crop injury as compared to, for example, a foliage treatment. Particularly, in the event of heavy rainfall or the like occurring after the treatment with an agrochemical composition and before the germination of cultivated crops, the agrochemical composition used for the soil treatment permeates deep into the soil, and the period of contact with the cultivated crops is thus extended, as a result of which a risk of causing crop injury through absorption into the cultivated crops is increased. In this process, if the soil were of a well-drained type such as sandy loam, the permeation rate of the agrochemical composition into the soil would be further increased due to the high water permeability of the soil and, if the seeding depth of the cultivated crops were shallow, the time required for the agrochemical composition to come into contact with the cultivated crops would be further shortened, as a result of which a risk of crop injury would be further increased. Accordingly, in the use of pyroxasulfone under such conditions, there is a concern of crop injury particularly for beans, such as soybean (Glycine max), peanut (Arachis hypogaea), azuki bean (Vigna angularis), common bean (Phaseolus vulgaris), and black-eyed pea (Vigna unguiculata).

Therefore, an agrochemical composition for soil treatment, which is highly safe for these cultivated crops and exhibits a broad herbicidal spectrum without being influenced by heavy rainfall, soil type, seeding depth and the like, has been desired.

Meanwhile, microencapsulation techniques for agrochemical active components are known and, for example, Non-Patent Document 1 discloses: microcapsules of various useful compounds such as agrochemical active components, which microcapsules contain various substances as wall materials; and a method of producing the microcapsules.

However, agrochemical compositions in which an elution control technique based on a masking substance, such as microencapsulation, is employed are used in environments where plenty of water is present such as paddy fields, and the use of such agrochemical compositions presupposes that their agrochemical active components will be eluted out with utilization of water in the field; therefore, these agrochemical compositions have been hardly used in fields that are scarce in water, such as farmland. In addition, agrochemical active components vary in terms of solubility in water even when they have similar chemical structures; therefore, even if their main skeletons are the same, these agrochemical active components are not necessarily suitable for the application of the above-described elution control technique based on a masking substance, and the agrochemical active components to which the elution control technique is applied have thus been limited. Under these circumstances, with regard to pyroxasulfone, an elution control technique suitable for soil treatment has not been known.

### RELATED ART DOCUMENT

### Non-Patent Document

[Non-Patent Document 1] Koishi et al. “Development and Application of the micro/nano fabrication system of capsules and fine particles”, Aug. 31, 2003, CMC Publishing Co., Ltd., full text.

### SUMMARY OF THE INVENTION

### Problems to be Solved by the Invention

As described above, pyroxasulfone has a broad herbicidal spectrum and, in order to further broaden the herbicidal spectrum, the present inventor examined the use of pyroxasulfone in combination with other herbicides. As a result, it was found that the use of pyroxasulfone in combination with a protoporphyrinogen oxidase inhibitor can broaden the herbicidal spectrum; however, this also has a problem of increasing adverse effects on cultivated crops, particularly causing crop injury through absorption into the cultivated crops at a level of Colby expected value or higher, depending on heavy rainfall after soil treatment, soil type, and seeding depth.

In view of the above, an object of the present invention is to provide a weed control method and a mixed agrochemical composition for soil treatment, which, in a soil treatment of farmland with pyroxasulfone, not only can inhibit or reduce crop injury caused by absorption into cultivated crops, without being influenced by heavy rainfall, soil type, seeding depth and the like, but also are effective against a wide range of weed species.

### Means for Solving the Problems

The present inventor intensively studied to solve the above-described problems and consequently discovered that the problems can be solved by, in the use of pyroxasulfone in combination with a protoporphyrinogen oxidase inhibitor, microencapsulating or coating pyroxasulfone with a masking substance to form a structure that prevents exposure of pyroxasulfone, thereby completing the present invention.

That is, the present invention encompasses the followings.

(1) A weed control method, including a soil treatment step of performing a soil treatment on farmland with an agrochemical composition for soil treatment, which contains pyroxasulfone, and with a protoporphyrinogen oxidase inhibitor, simultaneously or sequentially,

wherein the agrochemical composition for soil treatment further contains a masking substance that masks the pyroxasulfone, and the pyroxasulfone is microencapsulated in or coated with the masking substance.

(2) The method according to (1), wherein the protoporphyrinogen oxidase inhibitor is selected from the group consisting of saflufenacil, sulfentrazone, flumioxazin, flumiclorac-pentyl, fluthiacet-methyl, lactofen, fomesafen, acifluorfen and salts thereof, bifenox, chlomethoxyfen, oxyfluorfen, halosafen, cinidon-ethyl, carfentrazone-ethyl, azafenidin, benzfendizone, butafenacil, tiafenacil, pyraflufen-ethyl, fluazolate, thidiazimin, oxadiazon, oxadiargyl, chlorphthalim, pentoxazone, pyraclonil, flufenpyr-ethyl, and profluazol.

(3) The method according to (1), wherein the protoporphyrinogen oxidase inhibitor is selected from the group consisting of saflufenacil, sulfentrazone, and flumioxazin.

(4) The method according to any one of (1) to (3), wherein crystal particles of the pyroxasulfone are directly coated with the masking substance.

(5) The method according to any one of (1) to (3), wherein the pyroxasulfone is enclosed and microencapsulated in a wall material composed of the masking substance.

(6) The method according to any one of (1) to (5), wherein the agrochemical composition for soil treatment has an average particle size of 0.1 to 150 μm.

(7) The method according to any one of (1) to (6), wherein the content ratio of the masking substance is 0.1 to 50 parts by mass with respect to 1 part by mass of pyroxasulfone.

(8) The method according to any one of (1) to (7), wherein the masking substance is selected from the group consisting of polyureas, polyurethanes, polyamides, polyesters, ethyl cellulose, poly(meth)acrylate-based copolymers, carnauba wax, montanic acid ester waxes, hardened oils and fats, polylactic acids, gelatin, cross-linked melamine, polystyrenes, polystyrene-based copolymers, waxes, yeast cell walls, alginates, polyglycolic acids, polyethylene glycol-based copolymers, and shellac.

(9) The method according to any one of (1) to (8), further including performing a soil treatment with an agrochemical active component other than the pyroxasulfone and the protoporphyrinogen oxidase inhibitor, simultaneously or sequentially with the agrochemical composition for soil treatment.

(10) The method according to any one of (1) to (9), wherein the agrochemical composition for soil treatment has a dosage form of a dust, a granule, a wettable powder, a water-dispersible granule, an aqueous suspension formulation, or an oily suspension formulation.

(11) The method according to any one of (1) to (10), wherein the soil treatment step is performed before sprouting of a cultivated crop.

(12) The method according to (11), wherein the cultivated crop is a bean plant.

(13) The method according to (12), wherein the bean plant is soybean (Glycine max), peanut (Arachis hypogaea), azuki bean (Vigna angularis), common bean (Phaseolus vulgaris), or black-eyed pea (Vigna unguiculata).

(14) A mixed agrochemical composition for soil treatment, containing: an agrochemical composition for soil treatment, which contains pyroxasulfone; and a protoporphyrinogen oxidase inhibitor,

wherein the agrochemical composition for soil treatment further contains a masking substance that masks the pyroxasulfone, and the pyroxasulfone is microencapsulated in or coated with the masking substance.

(15) The mixed agrochemical composition for soil treatment according to (14), further containing an agrochemical active component other than the pyroxasulfone and the protoporphyrinogen oxidase inhibitor.

### Effects of the Invention

According to the present invention, a weed control method and a mixed agrochemical composition for soil treatment, which, in a soil treatment of farmland with pyroxasulfone, not only can inhibit or reduce crop injury caused by absorption into cultivated crops, without being influenced by heavy rainfall, soil type, seeding depth and the like, but also are effective against a wide range of weed species, can be provided.

### Mode for Carrying Out the Invention

### Weed Control Method

The weed control method of the present invention includes the soil treatment step of performing a soil treatment on farmland with an agrochemical composition for soil treatment, which contains pyroxasulfone, and with a protoporphyrinogen oxidase inhibitor (hereinafter, also referred to as “PPO inhibitor”), simultaneously or sequentially, the method being characterized in that: the agrochemical composition for soil treatment further contains a masking substance that masks the pyroxasulfone; and the pyroxasulfone is microencapsulated in or coated with the masking substance.

### Agrochemical Composition for Soil Treatment

The above-described agrochemical composition for soil treatment has a structure in which pyroxasulfone is microencapsulated in or coated with the masking substance so as to prevent exposure of pyroxasulfone. This agrochemical composition for soil treatment can be produced by, for example, a method of directly coating crystal particles of pyroxasulfone with a film composed of a resin serving as the masking substance, or a method of enclosing and microencapsulating pyroxasulfone in a wall material composed of a resin serving as the masking substance.

In the agrochemical composition for soil treatment, any known substance can be used as the masking substance, and specific examples thereof are described in, for example, Non-Patent Document 1. Particularly, polyureas, polyurethanes, polyamides, polyesters, ethyl cellulose, poly(meth)acrylate-based copolymers, carnauba wax, montanic acid ester waxes, hardened oils and fats, polylactic acids, gelatin, cross-linked melamine, polystyrenes, polystyrene-based copolymers, waxes, yeast cell walls, alginates, polyglycolic acids, polyethylene glycol-based copolymers, and shellac can be preferably used. In the agrochemical composition for soil treatment, the content ratio of the pyroxasulfone-masking substance is not particularly restricted; however, from the viewpoint of elution performance, it is preferably 0.1 to 50 parts by mass, more preferably 0.15 to 10 parts by mass, still more preferably 0.2 to 3 parts by mass, with respect to 1 part by mass of pyroxasulfone.

The method of directly coating crystal particles of pyroxasulfone with a film composed of a resin may be any known and commonly used method, and examples thereof include a production method in which pyroxasulfone and a heat-melted or solvent-dissolved resin are mixed and the resulting mixture is subsequently cooled to solidify the resin.

If desired, the above-described coating method may be carried out in the presence of an auxiliary agent capable of providing rubber elasticity, such as a silicone composite powder or a silicone rubber powder.

The method of enclosing and microencapsulating pyroxasulfone in a wall material composed of a resin may be any known and commonly used method and, for example, when the resin serving as the masking substance is a polyurea or a polyurethane, examples of the method include one that includes: the emulsification-dispersion step of stirring crystal particles of pyroxasulfone, an isocyanate, an oily phase, and an aqueous phase to emulsify and disperse the oily phase in the aqueous phase and to thereby form emulsion particles of the oily phase; and the film formation step of forming a film on at least the surfaces of the emulsion particles of the oily phase formed by the emulsification-dispersion step.

The isocyanate forming the polyurea and/or the polyurethane is preferably hydrophobic. Specific examples of the isocyanate include aliphatic or aromatic isocyanates, and the isocyanate is preferably an aromatic isocyanate. The isocyanate is also preferably a bi- or higher-functional polyisocyanate. Specific examples of isocyanates that can be used in the present invention include: monomers and oligomers (e.g., dimers and trimers) of aliphatic diisocyanates, such as hexamethylene diisocyanate; monomers and oligomers (e.g., dimers and trimers) of aromatic diisocyanates, such as toluene diisocyanate and diphenylmethane diisocyanate; and polymethylene polyphenyl polyisocyanates represented by the following Formula (I):

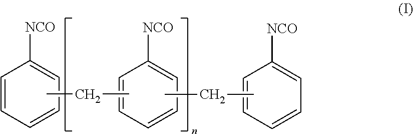

(wherein, n represents an integer of 1 or larger).

These isocyanates may be used individually, or in any combination of two or more thereof.

In the emulsification-dispersion step, it is preferred to use a polyester block copolymer. The polyester block copolymer used in the present invention may be a commercially available product and, for example, ATLOX RHEOSTRUX 100-PW(MV) manufactured by Croda International Plc. can be used. The content of the polyester block copolymer in the agrochemical composition for soil treatment is not particularly restricted; however, it is in a range of preferably 0.05 to 0.3% by mass, more preferably 0.1 to 0.3% by mass, still more preferably 0.1 to 0.2% by mass.

When a polyester block copolymer is used in the emulsification-dispersion step, it is preferred to stir crystal particles of pyroxasulfone, the polyester block copolymer, an isocyanate, an oily phase, and an aqueous phase at a high peripheral speed of 10,000 to 50,000 mm/s and to thereby emulsify and disperse the oily phase in the aqueous phase. From the viewpoint of biological effects such as herbicidal effect and crop injury-reducing effect, the peripheral speed is more preferably in a range of 10,000 to 40,000 mm/s, particularly preferably in a range of 15,000 to 35,000 mm/s. The high-speed stirring in such a range may be performed until emulsion particles of the oily phase are formed, and the duration of the high-speed stirring is in a range of usually 5 to 60 minutes, preferably 5 to 30 minutes, more preferably 10 to 30 minutes. It is noted here that the term “peripheral speed” used herein means the peripheral speed at the outermost circumference of a rotary blade of a stirrer.

The order of mixing the components in the emulsification-dispersion step is not particularly restricted; however, from the viewpoint of obtaining a superior crop injury-reducing effect, it is preferred to add the polyester block copolymer to the oily phase in advance by incorporating the step of mixing the polyester block copolymer with the oily phase before the emulsification-dispersion step. This is believed to be because, by the mixing of the polyester block copolymer with the oily phase in advance, the viscosity of the oily phase is increased, so that the difference in viscosity between the oily phase and the aqueous phase can be utilized to enclose pyroxasulfone into microcapsules efficiently.

Specific examples of a method of mixing the components include a method in which pyroxasulfone in a crystalline state is added to a mixture of the oily phase and the polyester block copolymer, and the isocyanate is further added to and dissolved or dispersed in the mixture, after which the aqueous phase is added and the resultant is mixed.

Examples of the method also include: a method in which the isocyanate is dissolved or dispersed in a mixture of the oily phase and the polyester block copolymer, and the aqueous phase is subsequently added to the mixture, followed by further addition of pyroxasulfone in a crystalline state and mixing of the resultant; and a method in which the isocyanate is dissolved or dispersed in a mixture of the oily phase and the polyester block copolymer, and pyroxasulfone in a crystalline state is subsequently added to the mixture, followed by further addition of the aqueous phase and mixing of the resultant.

The polyester block copolymer can be uniformly dispersed in the oily phase by the above-described high-speed stirring and, in cases where the polyester block copolymer is added to the oily phase in advance, it is preferred to obtain a mixture thereof by heating at a temperature of not lower than the melting temperature of the polyester block copolymer, for example, at a temperature of not lower than 80° C., since this improves the dispersibility of the polyester block copolymer in organic solvents.

In these mixing methods, stirring may be performed to dissolve, disperse, or mix the components. The stirring rate is not particularly restricted, and it may be, for example, 4,000 to 50,000 mm/s. Taking into consideration the biological effects such as herbicidal effect and crop injury-reducing effect, the peripheral speed is preferably 6,000 to 40,000 mm/s, more preferably 9,000 to 35,000 mm/s.

More specifically, the polyester block copolymer is added to the oily phase such as an organic solvent, and the resultant is heated to obtain a mixture and, in the subsequent emulsification-dispersion step, pyroxasulfone in a crystalline state is added to the thus obtained mixture at normal temperature, and the isocyanate is further added thereto with stirring at a peripheral speed of 4,000 to 30,000 mm/s, preferably 6,000 to 10,000 mm/s, after which the resulting mixture is stirred at a peripheral speed of preferably 4,000 to 30,000 mm/s, more preferably 6,000 to 10,000 mm/s, to dissolve or disperse the added materials. Thereafter, the aqueous phase is added, and the resultant is mixed and stirred at a high peripheral speed of 10,000 to 50,000 mm/s, preferably 10,000 to 40,000 mm/s, more preferably 15,000 to 35,000 mm/s, to emulsify and disperse the oily phase in the aqueous phase, whereby emulsion particles of the oily phase can be formed.

In another method, the polyester block copolymer is added to the oily phase such as an organic solvent, and the resultant is heated to obtain a mixture and, in the subsequent emulsification-dispersion step, the isocyanate is dissolved or dispersed in the thus obtained mixture with stirring at a peripheral speed of preferably 4,000 to 30,000 mm/s, more preferably 6,000 to 10,000 mm/s, followed by addition of the aqueous phase, after which pyroxasulfone in a crystalline state is added with stirring at a peripheral speed of preferably 10,000 to 50,000 mm/s, more preferably 10,000 to 40,000 mm/s, still more preferably 15,000 to 35,000 mm/s. Thereafter, the resultant is mixed and stirred at a high speed of 10,000 to 50,000 mm/s, preferably 10,000 to 40,000 mm/s, more preferably 15,000 to 35,000 mm/s, to emulsify and disperse the oily phase in the aqueous phase, whereby emulsion particles of the oily phase can be formed.

In yet another method, the polyester block copolymer is added to the oily phase such as an organic solvent, and the resultant is heated to obtain a mixture and, in the subsequent emulsification-dispersion step, the isocyanate is dissolved or dispersed in the thus obtained mixture with stirring at a peripheral speed of preferably 4,000 to 30,000 mm/s, more preferably 6,000 to 10,000 mm/s, followed by addition of pyroxasulfone in a crystalline state and mixing of the resultant, after which the aqueous phase is added with stirring at a peripheral speed of preferably 10,000 to 50,000 mm/s, more preferably 10,000 to 40,000 mm/s, still more preferably 15,000 to 35,000 mm/s. Thereafter, the resultant is mixed and stirred at a high speed of 10,000 to 50,000 mm/s, preferably 10,000 to 40,000 mm/s, more preferably 15,000 to 35,000 mm/s, to emulsify and disperse the oily phase in the aqueous phase, whereby emulsion particles of the oily phase can be formed.

In the step of adding the polyester block copolymer to the oily phase and heating the resultant to obtain a mixture, the heating temperature is desirably not lower than the melting temperature of the polyester block copolymer, for example, not lower than 80° C., in order to uniformly disperse the polyester block copolymer in the oily phase.

The mixture of the oily phase and the polyester block copolymer has a viscosity of preferably about 10 to 500 mPa·s, more preferably about 20 to 400 mPa·s, still more preferably about 30 to 300 mPa·s, at 20° C.

The oily phase used in the film formation step is not particularly restricted as long as it is capable of dissolving or dispersing therein the polyester block copolymer, pyroxasulfone and the isocyanate, and an organic solvent that can be used in a conventional microencapsulation method, preferably a hydrophobic organic solvent may be used as the oily phase. The oily phase has a viscosity of preferably about 10 to 500 mPa·s, more preferably about 20 to 400 mPa·s, still more preferably about 30 to 300 mPa·s, at 20° C.; however, assuming that the viscosity is increased by incorporation of the polyester block copolymer, an organic solvent having by itself a viscosity of less than 10 mPa·s can also be used without any problem.

Specific examples of the organic solvent include: ethers, such as ethyl ether, ethylene glycol monoethyl ether, dipropyl ether, and dibutyl ether; aliphatic hydrocarbons, such as n-paraffin, naphthene, isoparaffin, kerosene, and mineral oils; aromatic hydrocarbons, such as benzene, toluene, xylene, solvent naphtha, alkyl naphthalenes, and phenylxylylethane; halogenated hydrocarbons, such as dichloromethane, chloroform, and carbon tetrachloride; esters, such as ethyl acetate, diisopropyl phthalate, dibutyl phthalate, dioctyl phthalate, dimethyl adipate, diisobutyl adipate, and diisodecyl adipate; and vegetable oils, such as soybean oil, rapeseed oil, cottonseed oil and castor oil, among which an aromatic hydrocarbon, particularly phenylxylylethane is preferred.

The oily phase may further contain an additive(s) that can be used in a conventional microencapsulation method. It is desired that the additive(s) be selected as appropriate such that the oily phase has a viscosity in a range of preferably 10 to 500 mPa·s, more preferably 20 to 400 mPa·s, still more preferably 30 to 300 mPa·s, at 20° C. after the addition of the polyester block copolymer.

The aqueous phase used in the film formation step contains water as an indispensable component, and may further contain an emulsifier. The emulsifier is not restricted as long as it does not cause aggregation in the film formation step, and examples of the emulsifier include polyacrylic acid and water-soluble salts thereof, as well as polyethylene glycols, polyvinylpyrrolidones and polyvinyl alcohols, among which polyvinyl alcohols are preferred. Although the emulsifier may be added in the emulsification-dispersion step, the emulsifier is desirably dissolved in the aqueous phase in advance. Alternatively, the emulsifier may be dissolved in water and used in the form of an aqueous solution. The concentration of the emulsifier in the aqueous solution is not particularly restricted; however, it is usually selected in a range of 0.5 to 5% by mass.

In the film formation step, pyroxasulfone, the oily phase, and the polyester block copolymer are preferably blended in amounts of 1 to 30% by mass, 1 to 30% by mass and 0.01 to 1.0% by mass, respectively, with respect to a total amount of the raw materials of the pyroxasulfone-containing microcapsules to be obtained. The amount of the polyester block copolymer to be blended is more preferably 0.01 to 0.60% by mass, still more preferably 0.01 to 0.30% by mass, with respect to a total amount of the raw materials of the pyroxasulfone-containing microcapsules to be obtained. Further, the amount of the polyester block copolymer to be blended can be appropriately adjusted to be 0.001 to 0.1 parts by mass, preferably 0.005 to 0.05 parts by mass, more preferably 0.005 to 0.03 parts by mass, with respect to 1 part by mass of the oily phase.

The film formation step may be carried out by a film-forming process in a general microcapsule production method, and water in the aqueous phase may be allowed to react with the isocyanate at the liquid-liquid interface between the emulsion particles of the oily phase that have been formed in the above-described emulsification-dispersion step and the aqueous phase, or a water-soluble active hydrogen-containing compound may be further added to the aqueous phase and allowed to react with the isocyanate. In the film formation step, by allowing the isocyanate to react with at least either one of water and the water-soluble active hydrogen-containing compound in the aqueous phase, a polyurethane or polyurea film can be formed on at least the surfaces of the emulsion particles of the oily phase that have been formed in the above-described emulsification-dispersion step.

Reaction conditions for the film formation vary depending on the selected isocyanate, water-soluble active hydrogen compound, emulsifier, and organic solvent. For example, the film formation can be carried out by stirring these materials at room temperature, or with heating at a temperature of 50 to 100° C., preferably 50 to 80° C., for about 10 minutes to 6 hours, preferably about 1 to 4 hours. The stirring in this process may be performed at a peripheral speed of about 300 to 6,000 mm/s, and the peripheral speed is in a range of preferably 300 to 5,000 mm/s, more preferably 300 to 4,000 mm/s.

Examples of the water-soluble active hydrogen-containing compound that may be incorporated into the aqueous phase include polyols, polyamines and the like that contribute to crosslinking of the isocyanate in the film formation step, excluding those polyols that contribute as emulsifiers. A polyurethane is formed when the water-soluble active hydrogen-containing compound is a polyol, while a polyurea is formed when the water-soluble active hydrogen-containing compound is a polyamine. A polyurea is formed when the water-soluble active hydrogen-containing compound is not incorporated.

Specific examples of the polyols include glycol compounds and glycerin, and specific examples of the polyamines include ethylenediamine, diethylenetriamine, triethylenetetramine, and hexamethylenediamine. From the viewpoint of the elution of pyroxasulfone, a polyol, particularly a glycol compound containing a polyoxyethylene group and/or a polyoxypropylene group, is preferred. Specific examples of the glycol compound containing a polyoxyethylene group and/or a polyoxypropylene group include polyoxypropylene polyols and polyoxyethylene-polyoxypropylene block polymers (polyoxyethylene polyoxypropylene glycol), and a polyoxyethylene-polyoxypropylene block polymer is particularly preferred. These water-soluble active hydrogen-containing compounds may be used individually, or two or more thereof may be used in combination.

The water-soluble active hydrogen-containing compound may be added at any stage of the emulsification-dispersion step and the film formation step; however, a polyol, particularly a glycol compound containing a polyoxyethylene group and/or a polyoxypropylene group is preferably added in the film formation step.

The ratios of the isocyanate contained as a reactant in the oily phase, and the water-soluble active hydrogen-containing compound and the emulsifier that are used as desired, are each stoichiometrically set based on a reaction formula for the production of a polyurethane or a polyurea.

Preferably, the amount of the isocyanate to be blended may be selected to be in a range of 1 to 10 parts by mass, preferably 1 to 5 parts by mass, more preferably 1 to 3 parts by mass, with respect to 1 part by mass of crystal particles of pyroxasulfone. Further, a total amount of the isocyanate and the water-soluble active hydrogen-containing compound can be appropriately adjusted to be 1 to 10 parts by mass, preferably 1 to 7 parts by mass, more preferably 2 to 5 parts by mass, with respect to 1 part by mass of crystal particles of pyroxasulfone.

If desired, the microencapsulation of pyroxasulfone in the present invention may be carried out in the presence of a nonionic surfactant, such as a sorbitan fatty acid ester, a sucrose fatty acid ester, a polyoxyethylene fatty acid ester, a polyoxyethylene resin acid ester, a polyoxyethylene alkyl ether, a polyoxyethylene alkyl phenyl ether, an alkylpolyoxyethylene polypropylene block copolymer ether, a polyoxyalkylene styryl phenyl ether, a polyoxyethylene castor oil, or a polyoxyethylene hydrogenated castor oil; an anionic surfactant, such as an alkyl sulfate, an alkyl benzene sulfonate, a lignin sulfonate, an alkyl sulfosuccinate, naphthalene sulfonate, an alkylnaphthalene sulfonate, a naphthalene sulfonic acid formalin condensate salt, or an alkylnaphthalene sulfonic acid formalin condensate salt; and/or an antifoaming agent, such as a polyalkylsiloxane or a higher fatty acid salt. These additives may be incorporated into the oily phase or the aqueous phase in advance, or may be added separately from the oily phase and the aqueous phase.

In the microencapsulation of pyroxasulfone in the present invention, if desired, a water-soluble thickener such as xanthan gum, carboxymethyl cellulose or a salt thereof, gum arabic, gelatin, dextrin, or water-soluble starch, and/or a dispersant such as a naphthalene sulfonic acid formalin condensate salt may be added as well. The amount of the water-soluble thickener to be added is not particularly restricted; however, it is desirably in a range of 0.1 to 1.5 parts by mass with respect to 100 parts by mass of the agrochemical composition for soil treatment. The amount of the dispersant to be added is also not particularly restricted; however, it is desirably in a range of 1 to 10 parts by mass with respect to 100 parts by mass of the agrochemical composition for soil treatment.

The average particle size (volume median diameter) of the agrochemical composition for soil treatment that is obtained in the above-described manner can be selected as appropriate. The particle size is selected to be in a range of usually 0.1 to 150 μm, preferably 0.5 to 100 μm, still more preferably 1 to 50 μm.

In the agrochemical composition for soil treatment, as required, additive components that are normally used in agrochemical formulations may be arbitrarily incorporated.

Examples of the additive components include carriers such as solid carriers and liquid carriers, surfactants, binders, tackifiers, thickeners, colorants, extenders, spreaders, antifreezing agents, anticaking agents, disintegrants, stabilizing agents, and antifoaming agents. In addition, as required, preservatives, plant fragments and the like may be used as additive components. These additive components may be used individually, or two or more thereof may be used in combination.

Examples of the solid carriers include: natural minerals, such as quartz, clay, silica sand, kaolinite, pyrophyllite, sericite, talc, bentonite, acid clay, attapulgite, zeolite, and diatomaceous earth; inorganic salts, such as calcium carbonate, ammonium sulfate, sodium sulfate, and potassium chloride; organic solid carriers, such as synthetic silicic acid, synthetic silicates, starch, cellulose, and plant powders; plastic carriers, such as polyethylene, polypropylene, and polyvinylidene chloride; urea; inorganic hollow bodies; plastic hollow bodies; and fumed silica (white carbon). These solid carriers may be used individually, or two or more thereof may be used in combination.

Examples of the liquid carriers include: alcohols, for example, monohydric alcohols such as methanol, ethanol, propanol, isopropanol, and butanol, and polyhydric alcohols such as ethylene glycol, diethylene glycol, propylene glycol, hexylene glycol, polyethylene glycol, polypropylene glycol, and glycerin; polyhydric alcohol compounds, such as propylene glycol ether; ketones, such as acetone, methyl ethyl ketone, methyl isobutyl ketone, diisobutyl ketone, and cyclohexanone; ethers, such as ethyl ether, dioxane, ethylene glycol monoethyl ether, dipropyl ether, and tetrahydrofuran; aliphatic hydrocarbons, such as n-paraffin, naphthene, isoparaffin, kerosene, and mineral oils; aromatic hydrocarbons, such as benzene, toluene, xylene, solvent naphtha, alkylbenzenes, and alkylnaphthalenes; halogenated hydrocarbons, such as dichloromethane, chloroform, and carbon tetrachloride; esters such as ethyl acetate, diisopropyl phthalate, dibutyl phthalate, dioctyl phthalate, and dimethyl adipate; lactones, such as γ-butyrolactone; amides, such as dimethylformamide, diethylformamide, dimethylacetamide, and N-alkylpyrrolidinone; nitriles, such as acetonitrile; sulfur compounds, such as dimethyl sulfoxide; vegetable oils, such as soybean oil, rapeseed oil, cottonseed oil, and castor oil; and water. These liquid carriers may be used individually, or two or more thereof may be used in combination.

Examples of the surfactants include: nonionic surfactants, such as sorbitan fatty acid esters, polyoxyethylene sorbitan fatty acid esters, sucrose fatty acid esters, polyoxyethylene fatty acid esters, polyoxyethylene resin acid esters, polyoxyethylene fatty acid diesters, polyoxyethylene alkyl ethers, polyoxyethylene alkyl phenyl ethers, polyoxyethylene dialkyl phenyl ethers, polyoxyethylene alkyl phenyl ether formalin condensates, polyoxyethylene polyoxypropylene block copolymers, alkylpolyoxyethylene polypropylene block copolymer ethers, polyoxyethylene alkylamines, polyoxyethylene fatty acid amides, polyoxyethylene fatty acid bisphenyl ethers, polyalkylene benzyl phenyl ethers, polyoxyalkylene styryl phenyl ethers, acetylene diols, polyoxyalkylene-added acetylene diols, polyoxyethylene ether-type silicones, ester-type silicones, fluorine-based surfactants, polyoxyethylene castor oils, and polyoxyethylene hydrogenated castor oils; anionic surfactants, such as alkyl sulfates, polyoxyethylene alkyl ether sulfates, polyoxyethylene alkyl phenyl ether sulfates, polyoxyethylene styryl phenyl ether sulfates, alkyl benzene sulfonates, lignin sulfonates, alkyl sulfosuccinates, naphthalene sulfonates, alkyl naphthalene sulfonates, naphthalene sulfonic acid formalin condensate salts, alkyl naphthalene sulfonic acid formalin condensate salts, fatty acid salts, polycarboxylates, N-methyl-fatty acid sarcosinates, resinates, polyoxyethylene alkyl ether phosphates, and polyoxyethylene alkyl phenyl ether phosphates; cationic surfactants, for example, alkylamine salts such as laurylamine hydrochloride, stearylamine hydrochloride, oleylamine hydrochloride, stearylamine acetate, stearylaminopropylamine acetate, alkyltrimethyl ammonium chloride, and alkyldimethyl benzalkonium chloride; and amphoteric surfactants, such as amino acid-type or betaine-type surfactants. These surfactants may be used individually, or two or more thereof may be used in combination.

Examples of the binders and the tackifiers include carboxymethyl cellulose and salts thereof, dextrin, water-soluble starch, xanthan gum, guar gum, sucrose, polyvinylpyrrolidones, gum arabic, polyvinyl alcohols, polyvinyl acetates, sodium polyacrylates, polyoxyethylenes having an average molecular weight of 6,000 to 5,000,000, and phospholipids (e.g., cephalin and lecithin). These binders and the tackifiers may be used individually, or two or more thereof may be used in combination.

Examples of the thickeners include: water-soluble macromolecules, such as xanthan gum, guar gum, carboxymethyl cellulose, polyvinylpyrrolidones, carboxyvinyl polymers, acrylic polymers, starch derivatives, and polysaccharides; and inorganic fine powders, such as high-purity bentonite and fumed silica (white carbon). These thickeners may be used individually, or two or more thereof may be used in combination.

Examples of the colorants include: inorganic pigments, such as iron oxide, titanium oxide, and Prussian blue; and organic dyes, such as alizarin dyes, azo dyes, and metal phthalocyanine dyes. These colorants may be used individually, or two or more thereof may be used in combination.

Examples of the extenders include cellulose powders, dextrin, modified starch, polyaminocarboxylic acid chelate compounds, cross-linked polyvinylpyrrolidones, copolymers of maleic acid and styrene, (meth)acrylic acid-based copolymers, half esters formed by a polymer composed of polyhydric alcohol and a dicarboxylic anhydride, and water-soluble salts of polystyrene sulfonic acid. These extenders may be used individually, or two or more thereof may be used in combination.

Examples of the spreaders include paraffin, terpene, polyamide resins, polyacrylates, polyoxyethylenes, waxes, polyvinyl alkyl ethers, alkylphenol formalin condensates, starch phosphoric acid ester, and synthetic resin emulsions. These spreaders may be used individually, or two or more thereof may be used in combination.

Examples of the antifreezing agents include polyhydric alcohols, such as ethylene glycol, diethylene glycol, propylene glycol, and glycerin. These antifreezing agents may be used individually, or two or more thereof may be used in combination.

Examples of the anticaking agents include: polysaccharides, such as starch, alginic acid, mannose, and galactose; polyvinylpyrrolidones; fumed silica (white carbon); ester gum; and petroleum resins. These anticaking agents may be used individually, or two or more thereof may be used in combination.

Examples of the disintegrants include sodium tripolyphosphate, sodium hexametaphosphate, metal stearates, cellulose powders, dextrin, methacrylate copolymers, polyvinylpyrrolidones, polyaminocarboxylic acid chelate compounds, sulfonated styrene-isobutylene-maleic anhydride copolymers, and starch-polyacrylonitrile graft copolymers. These disintegrants may be used individually, or two or more thereof may be used in combination.

Examples of the stabilizing agents include: desiccants, such as zeolite, calcined lime, and magnesium oxide; antioxidants, such as phenol compounds, amine compounds, sulfur compounds, and phosphate compounds; and ultraviolet absorbers, such as salicylic acid compounds and benzophenone compounds. These stabilizing agents may be used individually, or two or more thereof may be used in combination.

Examples of the antifoaming agents include dimethylpolysiloxane, modified silicone, polyether, fatty acid esters, and fatty acid salts. These antifoaming agents may be used individually, or two or more thereof may be used in combination.

Examples of the preservatives include sodium benzoate, sodium parahydroxy benzoate, potassium sorbate, and 1,2-benzothiazolin-3-one. These preservatives may be used individually, or two or more thereof may be used in combination.

Examples of the plant fragments include sawdust, coconut shell, corn cob, and tobacco stem. These plant fragments may be used individually, or two or more thereof may be used in combination.

When the above-described additive components are incorporated into the agrochemical composition for soil treatment, their blending ratios are selected to be in the following respective ranges on a mass basis: for a carrier, usually 5 to 95%, preferably 20 to 90%; for a surfactant, usually 0.1 to 30%, preferably 0.5 to 10%; and for other additive components, usually 0.1 to 30%, preferably 0.5 to 10%.

As the agrochemical composition for soil treatment, a composition of a masking substance microencapsulating or coating pyroxasulfone may be used as is; however, the composition is usually formulated into an arbitrary dosage form such as a wettable powder, a dust, a water-dispersible granule, an aqueous suspension formulation, an oily suspension formulation, a granule, a Jumbo formulation, a suspoemulsion, or a uniformly dispersible formulation, along with the above-described additive components. Preferred dosage forms include dusts, granules, wettable powders, water-dispersible granules, aqueous suspension formulations, and oily suspension formulations.

When the agrochemical composition for soil treatment is in the form of granules, examples of the granules include those having a spherical shape with a particle size of 0.3 to 10 mm, a columnar shape, a spindle shape, or an irregular shape.

The spherical granule has a particle size of usually 0.3 to 10 mm, preferably 0.3 to 3 mm.

The columnar granule has a diameter of usually 0.6 to 5 mm, preferably 0.8 to 3 mm, and a grain length of usually 1 to 10 mm, preferably 1.5 to 8 mm.

The spindle granule has a minor axis of usually 0.3 to 3 mm, and a major axis of usually 1 to 10 mm.

When the agrochemical composition for soil treatment is in the form a uniformly dispersible formulation, it is preferred that the composition have a particle size distribution including not less than 80% by mass of granules having a particle size of 3 mm or larger; and that, when the composition is dropped into water, the composition floats on the water surface but disintegrates on the water surface within 30 minutes after the drop.

In the agrochemical composition for soil treatment, one or more other agrochemical active components may be arbitrarily mixed in addition to pyroxasulfone. The other agrochemical active component(s) may be incorporated in the form of being enclosed in or coated with the masking substance along with pyroxasulfone, or may be incorporated in the form of being enclosed in or coated with the masking substance separately from pyroxasulfone in accordance with the constitution of the composition of the present invention. Alternatively, an arbitrary agrochemical active component which does not have the masking structure of the present invention may be mixed within a range that does not impair the effects of the present invention. The term “arbitrary agrochemical active component” used herein encompasses pyroxasulfone as well. Further, the composition may be provided as a mixed composition with an arbitrary crop injury-reducing component(s) and/or an agricultural material(s) other than agrochemicals such as fertilizers.

As agrochemical active components that may be mixed, examples of herbicidal active components, insecticidal active components, antibacterial active components, and plant growth-regulating active components that may be blended are described below; however, the agrochemical active components in the present invention are not limited thereto.

### Herbicidal Active Components

Ioxynil, aclonifen, acrolein, azimsulfuron, asulam, acetochlor, atrazine, anilofos, amicarbazone, amidosulfuron, amitrole, aminocyclopyrachlor, aminopyralid, amiprofos-methyl, ametryn, alachlor, alloxydim, isouron, isoxachlortole, isoxaflutole, isoxaben, isoproturon, ipfencarbazone, imazaquin, imazapic (including salts with amine or the like), imazapyr (including salts with isopropylamine or the like), imazamethabenz-methyl, imazamox, imazethapyr, imazosulfuron, indaziflam, indanofan, eglinazine-ethyl, esprocarb, ethametsulfuron-methyl, ethalfluralin, ethidimuron, ethoxysulfuron, ethoxyfen-ethyl, ethofumesate, etobenzanid, endothal-disodium, oxaziclomefone, oxasulfuron, oryzalin, orthosulfamuron, orbencarb, oleic acid, cafenstrole, karbutilate, carbetamide, quizalofop-ethyl, quizalofop-P-ethyl, quizalofop-P-tefuryl, quinoclamine, quinclorac, quinmerac, cumyluron, clacyfos, glyphosate (including salts with sodium, potassium, ammonium, amine, propylamine, isopropylamine, dimethylamine, trimesium or the like), glufosinate (including salts with amine, sodium or the like), glufosinate-P-sodium, clethodim, clodinafop-propargyl, clopyralid, clomazone, clomeprop, cloransulam-methyl, chloramben, chloridazon, chlorimuron-ethyl, chlorsulfuron, chlorthal-dimethyl, chlorthiamid, chlorflurenol-methyl, chlorpropham, chlorbromuron, chloroxuron, chlorotoluron, ketospiradox (including salts with sodium, calcium, ammonia or the like), sarmentine, cyanazine, cyanamide, diuron, diethatyl-ethyl, dicamba (including salts with amine, diethylamine, isopropylamine, diglycol amine, sodium, lithium or the like), cycloate, cycloxydim, diclosulam, cyclosulfamuron, cyclopyranil, cyclopyrimorate, dichlobenil, diclofop-P-methyl, diclofop-methyl, dichlorprop, dichlorprop-P, diquat, dithiopyr, siduron, dinitramine, cinosulfuron, dinoseb, dinoterb, cyhalofop-butyl, diphenamid, difenzoquat, diflufenican, diflufenzopyr, simazine, dimethachlor, dimethametryn, dimethenamid, dimethenamid-P, simetryn, dimepiperate, dimefuron, cinmethylin, swep, sulcotrione, sulfosate, sulfosulfuron, sulfometuron-methyl, sethoxydim, terbacil, daimuron, thaxtomin A, dalapon, thiazopyr, thiencarbazone (including its sodium salt, methyl ester, and the like), tiocarbazil, thiobencarb, thifensulfuron-methyl, desmedipham, desmetryne, tetflupyrolimet, thenylchlor, tebutam, tebuthiuron, tepraloxydim, tefuryltrione, tembotrione, terbuthylazine, terbutryn, terbumeton, topramezone, tralkoxydim, triaziflam, triasulfuron, triafamone, tri-allate, trietazine, triclopyr, triclopyr-butotyl, trifludimoxazin, tritosulfuron, triflusulfuron-methyl, trifluralin, trifloxysulfuron-sodium, tribenuron-methyl, tolpyralate, naptalam (including salts with sodium or the like), naproanilide, napropamide, napropamide-M, nicosulfuron, neburon, norflurazon, vernolate, paraquat, halauxifen-benzyl, halauxifen-methyl, haloxyfop, haloxyfop-P, haloxyfop-etotyl, halosulfuron-methyl, bixlozone, picloram, picolinafen, bicyclopyrone, bispyribac-sodium, pinoxaden, piperophos, pyrasulfotole, pyrazoxyfen, pyrazosulfuron-ethyl, pyrazolynate, bilanafos, pyridafol, pyrithiobac-sodium, pyridate, pyriftalid, pyributicarb, pyribenzoxim, pyrimisulfan, pyriminobac-methyl, pyroxsulam, phenisopham, fenuron, fenoxasulfone, fenoxaprop (including its methyl, ethyl, and isopropyl esters), fenoxaprop-P (including its methyl, ethyl, and isopropyl esters), fenquinotrione, fenthiaprop-ethyl, fentrazamide, phenmedipham, butachlor, butamifos, butylate, butenachlor, butralin, butroxydim, flazasulfuron, flamprop (including its methyl, ethyl, and isopropyl esters), flamprop-M (including its methyl, ethyl, and isopropyl esters), primisulfuron-methyl, fluazifop-butyl, fluazifop-P-butyl, fluometuron, fluoroglycofen-ethyl, flucarbazone-sodium, fluchloralin, flucetosulfuron, flupyrsulfuron-methyl-sodium, flufenacet, flupropanate, flupoxame, flumetsulam, fluridone, flurtamone, fluroxypyr, flurochloridone, pretilachlor, procarbazone-sodium, prodiamine, prosulfuron, prosulfocarb, propaquizafop, propachlor, propazine, propanil, propyzamide, propisochlor, propyrisulfuron, propham, propoxycarbazone-sodium, profoxydim, bromacil, brompyrazon, prometryn, prometon, bromoxynil (including esters formed with butyric acid, octanoic acid, heptanoic acid or the like), bromofenoxim, bromobutide, florasulam, florpyrauxifen, hexazinone, pethoxamid, benazolin, penoxsulam, heptamaloxyloglucan, beflubutamid, beflubutamid-M, pebulate, pelargonic acid, bencarbazone, pendimethalin, bensulide, bensulfuron-methyl, benzobicyclon, benzofenap, bentazone, pentanochlor, benfluralin, benfuresate, fosamine, foramsulfuron, mecoprop (including salts with sodium, potassium, isopropylamine, triethanolamine, dimethylamine or the like), mecoprop-P-potassium, mesosulfuron-methyl, mesotrione, metazachlor, metazosulfuron, methabenzthiazuron, metamitron, metamifop, DSMA (disodium methane arsonate), methiozolin, methyldymuron, metoxuron, metosulam, metsulfuron-methyl, metobromuron, metobenzuron, metolachlor, metribuzin, mefenacet, monosulfuron (including its methyl, ethyl, and isopropyl esters), monolinuron, molinate, iodosulfuron, iodosulfulon-methyl-sodium, iofensulfuron, iofensulfuron-sodium, lancotrione, linuron, rimsulfuron, lenacil, TCA (2,2,2-trichloroacetic acid; including salts with sodium, calcium, ammonia or the like), 2,3,6-TBA (2,3,6-trichlorobenzoic acid), 2,4,5-T (2,4,5-trichlorophenoxyacetic acid), 2,4-D (2,4-dichlorophenoxyacetic acid; including salts with amine, diethylamine, triethanolamine, isopropylamine, sodium, lithium or the like), ACN (2-amino-3-chloro-1,4-naphthoquinone), MCPA (2-methyl-4-chlorophenoxyacetic acid), MCPB (2-methyl-4-chlorophenoxybutyric acid; including its sodium salt, ethyl ester, and the like), 2,4-DB (4-(2,4-dichlorophenoxy)butyric acid), DNOC (4,6-dinitro-o-cresol; including salts with amine, sodium or the like), AE-F-150944 (Code No.), HW-02 (Code No.), IR-6396 (Code No.), MCPA-thioethyl, SYP-298 (Code No.), SYP-300 (Code No.), EPTC (S-ethyldipropylthiocarbamate), S-metolachlor, S-9750 (Code No.), and MSMA.

### Insecticidal Active Components

Acrinathrin, azadirachtin, azamethiphos, azinphos-ethyl, azinphos-methyl, acequinocyl, acetamiprid, acetoprole, acephate, azocyclotin, abamectin, afidopyropen, afoxolaner, amidoflumet, amitraz, alanycarb, aldicarb, aldoxycarb, allethrin [including d-cis-trans-isomer and d-trans-isomer], isazophos, isamidofos, isocarbophos, isoxathion, isocycloseram, isofenphos-methyl, isoprocarb, ivermectin, imicyafos, imidacloprid, imiprothrin, indoxacarb, esfenvalerate, ethiofencarb, ethion, ethiprole, ethylene dibromide, etoxazole, etofenprox, ethoprophos, etrimfos, emamectin benzoate, endosulfan, empenthrin, oxazosulfyl, oxamyl, oxydemeton-methyl, oxydeprofos, omethoate, cadusafos, kappa-tefluthrin, kappa-bifenthrin, kadethrin, karanjin, cartap, carbaryl, carbosulfan, carbofuran, gamma-BHC, xylylcarb, quinalphos, kinoprene, chinomethionat, coumaphos, cryolite, clothianidin, clofentezine, chromafenozide, chlorantraniliprole, chlorethoxyfos, chlordane, chloropicrin, chlorpyrifos, chlorpyrifos-methyl, chlorfenapyr, chlorfenvinphos, chlorfluazuron, chlormephos, chloroprallethrin, cyanophos, diafenthiuron, diamidafos, cyantraniliprole, dienochlor, cyenopyrafen, dioxabenzofos, diofenolan, cyclaniliprole, dicrotophos, dichlofenthion, cycloprothrin, dichlorvos, dicloromezotiaz, 1,3-dichloropropene, dicofol, dicyclanil, disulfoton, dinotefuran, dinobuton, cyhalodiamide, cyhalothrin [including gamma-isomer and lambda-isomer], cyphenothrin [including (1R)-trans-isomer], cyfluthrin [including beta-isomer], diflubenzuron, cyflumetofen, diflovidazin, cyhexatin, cypermethrin [including alpha-isomer, beta-isomer, theta-isomer, and zeta-isomer], dimpropyridaz, dimethylvinphos, dimefluthrin, dimethoate, silafluofen, cyromazine, spinetoram, spinosad, spirodiclofen, spirotetramat, spiropidion, spiromesifen, sulcofuron-sodium, sulfluramid, sulfoxaflor, sulfotep, diazinon, thiacloprid, thiamethoxam, tioxazafen, thiodicarb, thiocyclam, thiosultap, thionazin, thiofanox, thiometon, tyclopyrazoflor, tetrachlorantraniliprole, tetrachlorvinphos, tetradifon, tetraniliprole, tetramethylfluthrin, tetramethrin, tebupirimfos, tebufenozide, tebufenpyrad, tefluthrin, teflubenzuron, demeton-S-methyl, temephos, deltamethrin, terbufos, tralomethrin, transfluthrin, triazamate, triazophos, trichlorfon, triflumuron, triflumezopyrim, trimethacarb, tolfenpyrad, naled, nitenpyram, novaluron, noviflumuron, Verticillium lecanii, hydroprene, Pasteuria penetrans spore, vamidothion, parathion, parathion-methyl, halfenprox, halofenozide, bioallethrin, bioallethrin S-cyclopentenyl, bioresmethrin, bistrifluron, hydramethylnon, bifenazate, bifenthrin, pyflubumide, piperonyl butoxide, pymetrozine, pyraclofos, pyrafluprole, pyridaphenthion, pyridaben, pyridalyl, pyrifluquinazon, pyriprole, pyriproxyfen, pirimicarb, pyrimidifen, pyriminostrobin, pirimiphos-methyl, pyrethrine, famphur, fipronil, fenazaquin, fenamiphos, fenitrothion, fenoxycarb, fenothiocarb, phenothrin [including (1R)-trans-isomer], fenobucarb, fenthion, phenthoate, fenvalerate, fenpyroximate, fenbutatin oxide, fenpropathrin, fonofos, sulfuryl fluoride, butocarboxim, butoxycarboxim, buprofezin, furathiocarb, prallethrin, fluacrypyrim, fluazaindolizine, fluazuron, fluensulfone, sodium fluoroacetate, fluxametamide, flucycloxuron, flucythrinate, flusulfamide, fluvalinate [including tau-isomer], flupyradifurone, flupyrazofos, flupyrimin, flufiprole, flufenerim, flufenoxystrobin, flufenoxuron, fluhexafon, flubendiamide, flumethrin, fluralaner, prothiofos, protrifenbute, flonicamid, propaphos, propargite, profenofos, broflanilide, brofluthrinate, profluthrin, propetamphos, propoxur, flometoquin, bromopropylate, hexythiazox, hexaflumuron, Paecilomyces tenuipes, Paecilomyces fumosoroceus, heptafluthrin, heptenophos, permethrin, benclothiaz, benzpyrimoxan, bensultap, benzoximate, bendiocarb, benfuracarb, Beauveria tenella, Beauveria bassiana, Beauveria brongniartii, phoxim, phosalone, fosthiazate, fosthietan, phosphamidon, phosmet, polynactin complex (polynactins), formetanate, phorate, malathion, milbemectin, mecarbam, mesulfenfos, methoprene, methomyl, metaflumizone, methamidophos, metham, methiocarb, methidathion, methyl isothiocyanate, methyl bromide, methoxychlor, methoxyfenozide, methothrin, metofluthrin, epsilon-metofluthrin, metolcarb, mevinphos, meperfluthrin, Monacrosporium phymatophagum, monocrotophos, momfluorothrin, epsilon-momfluorothrin, litlure-A, litlure-B, aluminum phosphide, zinc phosphide, phosphine, lufenuron, rescalure, resmethrin, lepimectin, rotenone, fenbutatin oxide, calcium cyanide, nicotine sulfate, (Z)-11-tetradecenyl=acetate, (Z)-11-hexadecenal, (Z)-11-hexadecenyl=acetate, (Z)-9,12-tetradecadienyl=acetate, (Z)-9-tetradecen-1-ol, (Z,E)-9,11-tetradecadienyl=acetate, (Z,E)-9,12-tetradecadienyl=acetate, Bacillus popilliae, Bacillus subtillis, Bacillus sphaericus, Bacillus thuringiensis subsp. Aizawai, Bacillus thuringiensis subsp. Israelensis, Bacillus thuringiensis subsp. Kurstaki, Bacillus thuringiensis subsp. Tenebrionis, Bt proteins (Cry1Ab, Cry1Ac, Cry1Fa, Cry2Ab, mCry3A, Cry3Ab, Cry3Bb, and Cry34/35Ab1), CL900167 (Code No.), DCIP (bis(2-chloro-1-methylethyl)ether), DDT (1,1,1-trichloro-2,2-bis(4-chlorophenyl)ethane), DEP (dimethyl-2,2,2-trichloro-1-hydroxyethylphosphonate), DNOC (4,6-dinitro-o-cresol), DSP (O,O-diethyl-O-[4-(dimethylsulfamoyl)phenyl]-phosphorothioate), EPN (O-ethyl-O-4-(nitrophenyl)phenylphosphorothioate), nuclear polyhedrosis virus occlusion body, NA-85 (Code No.), NA-89 (Code No.), NC-515 (Code No.), RU15525 (Code No.), XMC, Z-13-eicosen-10-one, ZXI8901 (Code No.), 2-chloro-4-fluoro-5-[5-(trifluoromethylthio)pentyloxy]phenyl-2,2,2-trifluoroethyl sulfoxide (chemical name, CAS No.: 1472050-04-6), 2,4-dicyclo-5-{2-[4-(trifluoromethyl)phenyl]ethoxy}phenyl-2,2,2-trifluoroethyl sulfoxide (chemical name, CAS No.: 1472052-11-1), 2,4-dimethyl-5-[6-(trifluoromethylthio)hexyloxy]phenyl-2,2,2-trifluoroethyl sulfoxide (chemical name, CAS No.: 1472050-34-2), 2-{2-fluoro-4-methyl-5-[(2,2,2-trifluoroethyl)sulfinyl]phenoxy}-5-(trifluoromethyl)pyridine (chemical name, CAS No.: 1448758-62-0), 3-chloro-2-{2-fluoro-4-methyl-5-[(2,2,2-trifluoroethyl)sulfinyl]phenoxy}-5-(trifluoromethyl)pyridine (chemical name, CAS No.: 1448761-28-1), and 4-fluoro-2-methyl-5-(5,5-dimethylhexyloxy)phenyl-2,2,2-trifluoroethyl sulfoxide (chemical name, CAS No.: 1472047-71-4), and NI-30 (Code No.).

### Antibacterial Active Components

Azaconazole, acibenzolar-S-methyl, azoxystrobin, anilazine, amisulbrom, aminopyrifen, ametoctradin, aldimorph, isotianil, isopyrazam, isofetamid, isoflucypram, isoprothiolane, ipconazole, ipflufenoquin, ipfentrifluconazole, iprodione, iprovalicarb, iprobenfos, imazalil, iminoctadine-trialbesilate, iminoctadine-triacetate, imibenconazole, inpyrfluxam, imprimatin A, imprimatin B, edifenphos, etaconazole, ethaboxam, ethirimol, ethoxyquin, etridiazole, enestroburin, enoxastrobin, epoxiconazole, organic oils, oxadixyl, oxazinylazole, oxathiapiprolin, oxycarboxin, oxine-copper, oxytetracycline, oxpoconazole-fumarate, oxolinic acid, copper dioctanoate, octhilinone, ofurace, orysastrobin, o-phenylphenol, kasugamycin, captafol, carpropamid, carbendazim, carboxin, carvone, quinoxyfen, quinofumelin, chinomethionat, captan, quinconazole, quintozene, guazatine, cufraneb, coumoxystrobin, kresoxim-methyl, clozylacon, chlozolinate, chlorothalonil, chloroneb, cyazofamid, diethofencarb, diclocymet, dichlofluanid, dichlobenthiazox, diclomezine, dicloran, dichlorophen, dithianon, diniconazole, diniconazole-M, zineb, dinocap, dipymetitrone, diphenylamine, difenoconazole, cyflufenamid, diflumetorim, cyproconazole, cyprodinil, simeconazole, dimethirimol, dimethyl disulfide, dimethomorph, cymoxanil, dimoxystrobin, ziram, silthiofam, streptomycin, spiroxamine, sedaxane, zoxamide, dazomet, tiadinil, thiabendazole, thiram, thiophanate, thiophanate-methyl, thifluzamide, tecnazene, tecloftalam, tetraconazole, debacarb, tebuconazole, tebufloquin, terbinafine, dodine, dodemorph, triadimenol, triadimefon, triazoxide, trichlamide, triclopyricarb, tricyclazole, triticonazole, tridemorph, triflumizole, trifloxystrobin, triforine, tolylfluanid, tolclofos-methyl, tolnifanide, tolprocarb, nabam, natamycin, naftifine, nitrapyrin, nitrothal-isopropyl, nuarimol, copper nonyl phenol sulphonate, Bacillus subtilis (strain: QST 713), validamycin, valifenalate, picarbutrazox, bixafen, picoxystrobin, pydiflumetofen, bitertanol, binapacryl, biphenyl, piperalin, hymexazol, pyraoxystrobin, pyraclostrobin, pyraziflumid, pyrazophos, pyrapropoyne, pyrametostrobin, pyriofenone, pyrisoxazole, pyridachlometyl, pyrifenox, pyributicarb, pyribencarb, pyrimethanil, pyroquilon, vinclozolin, ferbam, famoxadone, phenazine oxide, fenamidone, fenaminstrobin, fenarimol, fenoxanil, ferimzone, fenpiclonil, fenpicoxamid, fenpyrazamine, fenbuconazole, fenfuram, fenpropidin, fenpropimorph, fenhexamid, folpet, phthalide, bupirimate, fuberidazole, blasticidin-S, furametpyr, furalaxyl, furancarboxylic acid, fluazinam, fluindapyr, fluoxastrobin, fluoxapiprolin, fluopicolide, fluopimomide, fluopyram, fluoroimide, fluxapyroxad, fluquinconazole, furconazole, furconazole-cis, fludioxonil, flusilazole, flusulfamide, flutianil, flutolanil, flutriafol, flufenoxystrobin, flumetover, flumorph, proquinazid, prochloraz, procymidone, prothiocarb, prothioconazole, bronopol, propamocarb-hydrochloride, propiconazole, propineb, probenazole, bromuconazole, flometoquin, florylpicoxamid, hexaconazole, benalaxyl, benalaxyl-M, benodanil, benomyl, pefurazoate, penconazole, pencycuron, benzovindiflupyr, benthiazole, benthiavalicarb-isopropyl, penthiopyrad, penflufen, boscalid, fosetyl (aluminum, calcium, sodium), polyoxin, polycarbamate, Bordeaux mixture, mancozeb, mandipropamid, mandestrobin, maneb, myclobutanil, mineral oils, mildiomycin, methasulfocarb, metam, metalaxyl, metalaxyl-M, metiram, metyltetraprole, metconazole, metominostrobin, metrafenone, mepanipyrim, mefentrifluconazole, meptyldinocap, mepronil, iodocarb, laminarin, phosphorous acid and its salts, copper oxychloride, silver, cuprous oxide, copper hydroxide, potassium bicarbonate, sodium bicarbonate, sulfur, oxyquinoline sulfate, copper sulfate, (3,4-dichloroisothiazol-5 -yl)-methyl-4-(tert-butyl)benzoate (chemical name, CAS No. 1231214-23-5), BAF-045 (Code No.), BAG-010 (Code No.), UK-2A (Code No.), DBEDC (dodecylbenzenesulfonic acid bisethylenediamine copper complex salt [II]), MIF-1002 (Code No.), NF-180 (Code No.), TPTA (triphenyl tin acetate), TPTC (triphenyl tin chloride), TPTH (triphenyl tin hydroxide), and nonpathogenic Erwinia carotovora.

### Plant Growth-Regulating Active Components

1-methylcyclopropene, 1-naphthylacetamide, 2,6-diisopropylnaphthalene, 4-CPA (4-chlorophenoxyacetic acid), benzylaminopurine, ancymidol, aviglycine, carvone, chlormequat, cloprop, cloxyfonac, cloxyfonac-potassium, cyclanilide, cytokinins, daminozide, dikegulac, dimethipin, ethephon, epocholeone, ethychlozate, flumetralin, flurprimidol, flurenol, pronitridine, forchlorfenuron, gibberellins, inabenfide, indole acetic acid, indole butyric acid, maleic hydrazide, mefluidide, mepiquat chloride, n-decyl alcohol (n-decanol), paclobutrazol, prohexadione-calcium, prohydrojasmon, sintofen, thidiazuron, triacontanol, trinexapac-ethyl, uniconazole, uniconazole-P, 4-oxo-4-(2-phenylethyl)aminobutyric acid (chemical name, CAS No.: 1083-55-2), and calcium peroxide.

Examples of crop injury-reducing components that may be blended are described below; however, the crop injury-reducing components in the present invention are not limited thereto.

### Crop Injury-Reducing Components

AD-67 (4-dichloroacetyl-1-oxa-4-azaspiro[4.5]decane), DKA-24 (N1,N2-diallyl-N2-dichloroacetylglycinamide), MG-191 (2-dichloromethyl-2-methyl-1,3-dioxane), N-(2-methoxybenzoyl)-4-[(methylaminocarbonyl)amino]benzenesulfonamide (chemical name, CAS No.: 129531-12-0), PPG-1292 (2,2-dichloro-N-(1,3-dioxan-2-ylmethyl)-N-(2-propenyl)acetamide), R-29148 (3 -dichloroacetyl-2,2,5 -trimethyl-1,3-oxazolidine), TI-35 (1-dichloroacetylazepane), isoxadifen, isoxadifen-ethyl, oxabetrinil, cloquintcet-mexyl, cyometrinil, dichlormid, dicyclonone, cyprosulfamide, 1,8-naphthalic anhydride, fenchlorazole-ethyl, fenclorim, furilazole, fluxofenim, flurazole, benoxacor, mefenpyr, mefenpyr-ethyl, mefenpyr-diethyl, and lower alkyl-substituted benzoic acid.

The above-described agrochemical composition for soil treatment that is formulated into any of the above-described dosage forms may be wrapped with a water-soluble film, and this can not only contribute to labor saving in applying the composition but also improve the safety.

A method of producing the agrochemical composition for soil treatment is not particularly restricted, and any of the following methods is usually employed:

(1) A method in which an appropriate amount of water is added to a mixture of pyroxasulfone microencapsulated in or coated with a masking substance and other raw materials, and this mixture is kneaded and then extrusion-granulated through a screen having holes of a certain size, followed by drying;

(2) a method in which pyroxasulfone microencapsulated in or coated with a masking substance and other raw materials are mixed and uniformly suspended in water or an appropriate solvent; and

(3) a method in which pyroxasulfone microencapsulated in or coated with a masking substance is mixed with an appropriate carrier, and the resulting mixture is dried and then mixed with other raw materials.

### Protoporphyrinogen Oxidase Inhibitor (PPO Inhibitor)

The PPO inhibitor used in the present invention is selected from the group consisting of saflufenacil, sulfentrazone, flumioxazin, flumiclorac-pentyl, fluthiacet-methyl, lactofen, fomesafen, acifluorfen and salts thereof, bifenox, chlomethoxyfen, oxyfluorfen, halosafen, cinidon-ethyl, carfentrazone-ethyl, azafenidin, benzfendizone, butafenacil, tiafenacil, pyraflufen-ethyl, fluazolate, thidiazimin, oxadiazon, oxadiargyl, chlorphthalim, pentoxazone, pyraclonil, flufenpyr-ethyl, and profluazol. Thereamong, the PPO inhibitor is preferably a compound selected from the group consisting of saflufenacil, sulfentrazone, flumioxazin, flumiclorac-pentyl, fluthiacet-methyl, lactofen, fomesafen, acifluorfen and salts thereof, bifenox, tiafenacil, and flufenpyr-ethyl, particularly preferably a compound selected from the group consisting of saflufenacil, sulfentrazone, and flumioxazin. These PPO inhibitors may be used individually, or two or more thereof may be used in combination.

The PPO inhibitor may be used as is; however, the PPO inhibitor is usually formulated into an arbitrary dosage form such as a wettable powder, a dust, a water-dispersible granule, an aqueous suspension formulation, an oily suspension formulation, a granule, a Jumbo formulation, a suspoemulsion, or a uniformly dispersible formulation, along with the above-described additive components that are usually used in agrochemical formulations.

When the PPO inhibitor is formulated, one or more other agrochemical active components may be arbitrarily mixed within a range that does not impair the effects of the present invention. Examples of the other agrochemical active components include those that may be used in the above-described agrochemical composition for soil treatment. Further, the PPO inhibitor can also be formulated into a mixed formulation along with an arbitrary crop injury-reducing component(s) and/or an agricultural material(s) other than agrochemicals such as fertilizers.

It is important that the weed control method of the present invention include the soil treatment step of performing a soil treatment on farmland with the above-described agrochemical composition for soil treatment of the present invention and with the above-described PPO inhibitor, simultaneously or sequentially. The soil treatment step is preferably performed before sprouting of cultivated crops, and may be performed before or after seeding. A method for this soil treatment is not particularly restricted, and the soil treatment may be performed in accordance with a commonly used conventional method depending on the dosage form of the composition. The soil type to which the present invention can be applied is not particularly restricted, and crop injury through absorption can be inhibited or reduced even on a well-drained soil, such as sandy soil, sandy loam, loamy sand, sandy clay loam, sandy clay soil, or light clay soil. In addition, crop injury through absorption can be inhibited or reduced even when the cultivated crops are seeded at a shallow depth of 0 to 2 cm.

Further, in the present invention, an excellent weed control effect enables to reduce the amount of both the agrochemical composition for soil treatment and the PPO inhibitor. In the above-described soil treatment step, the spraying amount of the agrochemical composition for soil treatment varies depending on the dosage form, the environmental conditions and the like; however, it is selected as appropriate such that, for example, the amount of pyroxasulfone per 1 ha is in a range of 1 to 10,000 g, preferably 10 to 1,000 g. The spraying amount of the PPO inhibitor also varies depending on the dosage form, the environmental conditions and the like; however, it is selected as appropriate such that, for example, the amount of the PPO inhibitor per 1 ha is in a range of 1 to 10,000 g, preferably 10 to 1,000 g.

The spraying ratio of the agrochemical composition for soil treatment and the PPO inhibitor is not particularly restricted; however, the ratio of pyroxasulfone and the PPO inhibitor is in a range of preferably 100:1 to 1:100, particularly preferably 10:1 to 1:10.

Further, in the weed control method of the present invention, a soil treatment may be performed with an agrochemical active component other than pyroxasulfone and the PPO inhibitor, simultaneously or sequentially with the agrochemical composition for soil treatment. Examples of the agrochemical active component include the above-described other agrochemical active components that may be used in the agrochemical composition for soil treatment.

In the weed control method of the present invention, the cultivated crop is not particularly restricted; however, it is preferably a crop that can be cultivated on farmland. Particularly, in wheats such as common wheat (Triticum aestivum), barley (Hordeum vulgare) and durum wheat (Triticum durum), as well as beans such as soybean (Glycine max), peanut (Arachis hypogaea), azuki bean (Vigna angularis), common bean (Phaseolus vulgaris) and black-eyed pea (Vigna unguiculata), an agrochemical is likely to cause crop injury in the event of heavy rainfall after the application of the agrochemical but before sprouting, and such crop injury can be notably inhibited by the present invention regardless of the soil type and the seeding depth; therefore, the weed control method of the present invention can be especially suitably employed on these crops. The above-described crop may be of a naturally-occurring variety, or a variety produced by some sort of artificial manipulation. In the present specification, unless otherwise specified, the terms “cultivated crop” and “crop” are used to encompass both a naturally-occurring variety and a variety produced by artificial manipulation.

Examples of the artificial manipulation include operations of imparting resistance, such as pest resistance, disease resistance or herbicide resistance, by a breeding method based on gene recombination technology, artificial crossing, or the like. The operations of imparting resistance include not only those resistance-imparting operations based on classic intervarietal crossing or gene recombination technology, but also the operations of imparting resistance by a new plant breeding technique (NBT) that is a combination of a conventional breeding technique and a molecular biological technique. NBTs are described in, for example, a book titled “Understanding NBT (New Plant Breeding Techniques)” (Ryo Osawa and Hiroshi Ezura, published by International Academic Publishing Co., Ltd.) and a review article “Genome Editing Tools in Plants” (Genes 2017, 8, 399, Tapan Kumar Mohanta, Tufail Bashir, Abeer Hashem, Elsayed Fathi Abd_Allah, and Hanhong Bae).

### Mixed Agrochemical Composition for Soil Treatment

The mixed agrochemical composition for soil treatment of the present invention contains the above-described agrochemical composition for soil treatment and the above-described PPO inhibitor, and is characterized in that the agrochemical composition for soil treatment further contains a masking substance that masks the pyroxasulfone, and the pyroxasulfone is microencapsulated in or coated with the masking substance. The mixed agrochemical composition for soil treatment of the present invention may further contain the above-described agrochemical active component(s) other than pyroxasulfone and the PPO inhibitor.

### EXAMPLES

The present invention will now be described in detail by way of Examples and Test Examples; however, the present invention is not restricted by these Examples at any rate. In the below-described Examples, “part(s)” means part(s) by mass, and “%” means % by mass.

### Preparation Example 1

A mixture was obtained by stirring 5 parts of phenylxylylethane (trade name “HISOL SAS-296”, manufactured by Asahi Petrochemicals, Co., Ltd., viscosity at 20° C.=lower than 10 mPa·s (measured by a B-type viscometer (manufactured by Toki Sangyo Co., Ltd.); the same applies below)) with 0.05 parts of a polyester block copolymer (trade name “ATLOX RHEOSTRUX 100-PW(MV)” manufactured by Croda International Plc) under heating at 80° C. using a dissolver (trade name “TK ROBOMIX”, manufactured by PRIMIX Corporation). The thus obtained mixture had a viscosity of 52 mPa·s at 20° C. To this mixture, 5.1 parts of pyroxasulfone was added, and the resulting mixture was stirred at 30° C. for 15 minutes at a peripheral speed of 9,425 mm/s, after which 15 parts of an isocyanate (trade name “CORONATE 1130”, manufactured by Tosoh Corporation) was further added, and the resulting mixture was stirred at a peripheral speed of 9,425 mm/s. Then, 68.51 parts of a 1% aqueous polyvinyl alcohol solution and 0.1 parts of a silicone-based antifoaming agent (trade name “ASAHI SILICONE AF-128”, manufactured by Asahi Dyestuff MFG. Co., Ltd.) were further added, and the resulting mixture was stirred at a peripheral speed 25,133 mm/s for 10 minutes to obtain a suspension solution. Subsequently, the thus obtained suspension solution was stirred at a peripheral speed of 628 mm/s with heating from 30° C. at a heating rate of 1° C./min for 30 minutes, and then further stirred at a peripheral speed of 628 mm/s for 2.5 hours while the temperature was maintained at 60° C., followed by addition of 2.0 parts of a polyoxyethylene polyoxypropylene block copolymer (trade name “EPAN 410”, manufactured by DKS Co., Ltd.) and further stirring for 1 hour. After the completion of reaction, 4.0 parts of sodium salt of a naphthalene sulfonic acid formaldehyde condensate (trade name “DEMOL SN-B”, manufactured by Kao Corporation) was added at room temperature, and the resulting mixture was stirred at a peripheral speed of 3,142 mm/s for 5 minutes, followed by addition of 0.2 parts of xanthan gum (trade name “KELZAN”, manufactured by SANSHO Co., Ltd.) and stirring for 10 minutes, after which the resultant was screened through a sieve having openings of about 300 μm (48 mesh), whereby a microencapsulated pyroxasulfone-containing agrochemical composition for soil treatment, which contained a polyurea as a masking substance, was obtained. This composition was in the form of spherical particles having an average particle size of 15.4 μm.

### Preparation Example 2

A mixture was obtained by stirring 5 parts of phenylxylylethane (trade name “HISOL SAS-296”, manufactured by Asahi Petrochemicals, Co., Ltd., viscosity at 20° C.=lower than 10 mPa·s (measured by a B-type viscometer (manufactured by Toki Sangyo Co., Ltd.); the same applies below)) with 0.05 parts of a polyester block copolymer (trade name “ATLOX RHEOSTRUX 100-PW(MV)” manufactured by Croda International Plc) under heating at 80° C. using a dissolver (trade name “TK ROBOMIX”, manufactured by PRIMIX Corporation). The thus obtained mixture had a viscosity of 52 mPa·s at 20° C. To this mixture, 5.1 parts of pyroxasulfone was added, and the resulting mixture was stirred at 30° C. for 15 minutes at a peripheral speed of 9,425 mm/s, after which 15 parts of an isocyanate (trade name “SUMIDUR 44V10”, manufactured by Sumika Bayer Co., Ltd.) was further added, and the resulting mixture was stirred at a peripheral speed of 9,425 mm/s. Then, 68.51 parts of a 1% aqueous polyvinyl alcohol solution and 0.1 parts of a silicone-based antifoaming agent (trade name “ASAHI SILICONE AF-128”, manufactured by Asahi Dyestuff MFG. Co., Ltd.) were further added, and the resulting mixture was stirred at a peripheral speed of 31,416 mm/s for 5 minutes to obtain a suspension solution. Subsequently, the thus obtained suspension solution was stirred at a peripheral speed of 628 mm/s with heating from 30° C. at a heating rate of 1° C./min for 30 minutes, and then further stirred at a peripheral speed of 628 mm/s for 2.5 hours while the temperature was maintained at 60° C., followed by addition of 2.0 parts of a polyoxyethylene polyoxypropylene block copolymer (trade name “EPAN 410”, manufactured by DKS Co., Ltd.) and further stirring for 1 hour. After the completion of reaction, 4.0 parts of sodium salt of a naphthalene sulfonic acid formaldehyde condensate (trade name “DEMOL SN-B”, manufactured by Kao Corporation) was added at room temperature, and the resulting mixture was stirred at a peripheral speed of 3,142 mm/s for 10 minutes, followed by addition of 0.2 parts of xanthan gum (trade name “KELZAN”, manufactured by SANSHO Co., Ltd.) and stirring for 10 minutes, after which the resultant was screened through a sieve having openings of about 300 μm (48 mesh), whereby a microencapsulated pyroxasulfone-containing agrochemical composition for soil treatment, which contained a polyurea as a masking substance, was obtained. This composition was in the form of spherical particles having an average particle size of 8.8 μm.

### Comparative Preparation Example 1

After adding and mixing 50 parts of pyroxasulfone, 3 parts of sodium alkylnaphthalene sulfonate, 2 parts of polyoxyethylene alkylphenyl ether, 5 parts of sodium lignin sulfonate, 18 parts of diatomaceous earth and 22 parts of clay, the resulting mixture was pulverized and subsequently kneaded with an addition of water in an appropriate amount. Thereafter, the resultant was extrusion-granulated through a screen of 0.7 mm in mesh size using an extrusion granulator and then size-sorted, followed by drying at a product temperature of 60° C. and sieving, whereby a pyroxasulfone-containing wettable powder was obtained.

### Test Example 1: Herbicidal Effect Evaluation Test on Weeds by Soil Treatment

In a greenhouse having an average temperature of 25° C. (highest: 30° C., lowest: 25° C.), field soil (sandy loam) was filled in a plastic pot of 11 cm in length, width and depth, and twenty seeds of each of barnyard grass (Echinochloa crus-galli) and redroot amaranth (Amaranthus retroflexus) were sowed and covered with the same soil at a thickness of 1 cm. Subsequently, the agrochemical composition for soil treatment which was obtained in Preparation Example 1 or the wettable powder obtained in Comparative Preparation Example 1 and a PPO inhibitor were weighed such that the amount of pyroxasulfone per hectare would be as shown in Table 1, and then diluted with water and uniformly sprayed to the soil using a small sprayer. On the day of this chemical treatment, a total of 2-mm rainfall was artificially applied in 30 minutes using an artificial rain maker. Thereafter, barnyard grass and redroot amaranth were grown and, on Day 18 after the treatment, the growth conditions of barnyard grass and redroot amaranth were observed and examined. The rates of reduction in the plant height and the number of leaves relative to an untreated area were each calculated, and the herbicidal effect was determined as a value obtained by adding the thus calculated rates of reduction and dividing this value by 2 for evaluation of the degree of the herbicidal effect. For example, the herbicidal effect is 90% when the plant height was decreased by 90% and the number of leaves was reduced from 10 to 1, while the herbicidal effect is 75% when the plant height was decreased by 70% and the number of leaves was reduced from 5 to 1. The results of the examination are shown in Table 1. It is noted here that, in Table 1, each value of the herbicidal effect represents an average value of two herbicidal effect evaluation tests.

TABLE 1

| | | | | Barnyard | Redroot |
|---|---|---|---|---|---|
| | | | Amount of | grass | amaranth |
| | | | component | Day 18 after | Day 18 after |
| | | | (g/ha) | treatment | treatment |
| | | | active | (4.2 L)*¹ | (4 L)*¹ |
| Comparative | 1 | Preparation Example 1 | 90 | 100 | 97 |
| Examples | 2 | pyroxasulfone) | | | |
| | | (microencapsulated | 180 | 100 | 97 |
| | 3 | Comparative Preparation | 90 | 100 | 94 |
| | 4 | Example 1 (pyroxasulfone) | 180 | 100 | 94 |
| | 5 | Flumioxazin*² | 70 | 100 | 100 |
| | 6 | | 140 | 100 | 100 |
| | 7 | Saflufenacil*³ | 25 | 15 | 100 |
| | 8 | | 50 | 65 | 100 |
| | 9 | Sulfentrazone*⁴ | 160 | 100 | 100 |
| | 10 | | 320 | 100 | 100 |
| Examples | 1 | Preparation Example 1 + | 90 + 70 | 100 | 100 |
| | 2 | flumioxazin | 180 + 140 | 100 | 100 |
| | 3 | Preparation Example 1 + | 90 + 25 | 100 | 100 |
| | 4 | saflufenacil | 180 + 50 | 100 | 100 |
| | 5 | Preparation Example 1 + | 90 + 160 | 100 | 100 |
| | 6 | sulfentrazone | 180 + 320 | 100 | 100 |
| Comparative | 11 | Comparative Preparation | 90 + 70 | 100 | 100 |
| Examples | 12 | Example 1 + flumioxazin | 180 + 140 | 100 | 100 |
| | 13 | Comparative Preparation | 90 + 25 | 100 | 100 |
| | 14 | Example 1 + saflufenacil | 180 + 50 | 100 | 100 |
| | 15 | Comparative Preparation | 90 + 160 | 100 | 100 |
| | 16 | Example 1 + sulfentrazone | 180 + 320 | 100 | 100 |

*¹The leaf stage at the time of examination is shown in parentheses.
*²flumioxazin water-dispersible granule (trade name “VALOR SX”, manufactured by Valent LLC)
*³saflufenacil aqueous suspension formulation (trade name “SHARPEN”, manufactured by BASF Japan, Ltd.)
*⁴sulfentrazone aqueous suspension formulation (trade name “SPARTAN FL 4F”, manufactured by FMC Corporation)

### Test Example 2: Evaluation Test of Crop Injury to Soybean by Soil Treatment

In a greenhouse having an average temperature of 25° C. (highest: 30° C., lowest: 25° C.), field soil (sandy loam) was filled in a plastic pot of 11 cm in length, width and depth, and a single seed of soybean (Glycine max) was sowed and covered with the same soil at a thickness of 2 cm. Subsequently, the agrochemical composition for soil treatment which was obtained in Preparation Example 1 or 2 or the wettable powder obtained in Comparative Preparation Example 1 and a PPO inhibitor were weighed such that the amount of pyroxasulfone per hectare would be as shown in Tables 2 to 5, and then diluted with water and uniformly sprayed to the soil over the soybean using a small sprayer. On the day of this chemical treatment, a total of 15-mm rainfall was artificially applied in 30 minutes using an artificial rain maker. Thereafter, the soybean was grown and, on Day 15 and Day 39 after the treatment or on Day 13 and Day 26 after the treatment, the growth conditions of the soybean were observed and examined in terms of the plant height and the number of leaves. The rates of reduction in the plant height and the number of leaves relative to an untreated area were each determined, and the thus determined rates of reduction were added and then divided by 2 to calculate the growth inhibition rate for evaluation of the degree of crop injury. For example, the growth inhibition rate is 10% when the plant height was decreased by 10% and the number of leaves was reduced from 10 to 9, while the growth inhibition rate is 25% when the plant height was decreased by 30% and the number of leaves was reduced from 5 to 4. The results of the examination are shown in Tables 2 to 5. It is noted here that, in Tables 2 to 5, each growth inhibition rate represents an average value of two crop injury evaluation tests.

In this Test Example 2, an effect lower than a formal sum of the crop injury levels caused by the individual use of two chemical agents, i.e., the agrochemical composition for soil treatment or the wettable powder and a PPO inhibitor, was observed with a combination of the present inventions. The values observed in the test each indicated an effect lower than the expected value calculated by the following Colby formula at a preferable dosage (see S. R. Colby, Weeds 15(1967), pp. 20-22). Colby's formula defines the expected value (E) as follows for the use of a combination of two chemical agents:

(E)=X+Y−XY/100

wherein X represents the growth inhibition rate of an agent a at a concentration of x, and Y represents the growth inhibition rate of an agent b at a concentration of y.

TABLE 2

| | | | Soybean growth | |
|---|---|---|---|---|
| | | | inhibition rate | |
| | | Amount of | (%) | |
| | | active | Day 15 | Day 39 |
| | | component | after | after |
| | | (g/ha) | treatment | treatment |
| Comparative | Preparation Example 2 | 90 | 10 | 5 |
| Example 17 | (microencapsulated | | | |
| | pyroxasulfone) | | | |
| Comparative | Comparative | 90 | 10 | 13 |
| Example 3 | Preparation | | | |
| | Example 1 | | | |
| | (pyroxasulfone) | | | |
| Comparative | Flumioxazin | 70 | 15 | 5 |
| Example 5 | | | | |
| Example 7 | Preparation Example | 90 + 70 | 15(24)*⁵ | 5(10)*⁵ |
| | 2 + flumioxazin | | | |
| Comparative | Comparative | 90 + 70 | 25(24)*⁵ | 20(17)*⁵ |
| Example 11 | Preparation | | | |
| | Example 1 + | | | |
| | flumioxazin | | | |

*⁵The Colby expected value is shown in parentheses.

TABLE 3

| | | | Soybean growth | |
|---|---|---|---|---|
| | | | inhibition rate | |
| | | Amount of | (%) | |
| | | active | Day 15 | Day 39 |
| | | component | after | after |
| | | (g/ha) | treatment | treatment |
| Comparative | Preparation Example 2 | 180 | 10 | 8 |
| Example 18 | (microencapsulated | | | |
| | pyroxasulfone) | | | |
| Comparative | Comparative | 180 | 15 | 13 |
| Example 4 | Preparation | | | |
| | Example 1 | | | |
| | (pyroxasulfone) | | | |
| Comparative | Flumioxazin | 140 | 25 | 10 |
| Example 6 | | | | |
| Example 8 | Preparation Example | 180 + 140 | 20(33)*⁵ | 5(17)*⁵ |
| | 2 + flumioxazin | | | |
| Comparative | Comparative | 180 + 140 | 65(36)*⁵ | 25(22)*⁵ |
| Example 12 | Preparation | | | |
| | Example 1 + | | | |
| | flumioxazin | | | |

*⁵The Colby expected value is shown in parentheses.

TABLE 4

| | | | Soybean growth | |
|---|---|---|---|---|
| | | Amount of | inhibition rate (%) | |
| | | active | Day 13 | Day 26 |
| | | component | after | after |
| | | (g/ha) | treatment | treatment |
| Comparative | Preparation Example 1 | 90 | 10 | 5 |
| Example 1 | (microencapsulated | | | |
| | pyroxasulfone) | | | |
| Comparative | Comparative | 90 | 10 | 10 |
| Example 3 | Preparation | | | |
| | Example 1 | | | |
| | (pyroxasulfone) | | | |
| Comparative | Flumioxazin | 70 | 8 | 10 |
| Example 5 | | | | |
| Comparative | Saflufenacil | 25 | 20 | 30 |
| Example 7 | | | | |
| Comparative | Sulfentrazone | 160 | 25 | 20 |
| Example 9 | | | | |
| Example 1 | Preparation | 90 + 70 | 5(17)*⁵ | 5(15)*⁵ |
| | Example 1 + | | | |
| | flumioxazin | | | |
| Example 3 | Preparation | 90 + 25 | 20(28)*⁵ | 18(34)*⁵ |
| | Example 1 + | | | |
| | saflufenacil | | | |
| Example 5 | Preparation | 90 + 160 | 20(33)*⁵ | 20(24)*⁵ |
| | Example 1 + | | | |
| | sulfentrazone | | | |
| Comparative | Comparative | 90 + 70 | 25(17)*⁵ | 20(19)*⁵ |
| Example 11 | Preparation | | | |
| | Example 1 + | | | |
| | flumioxazin | | | |
| Comparative | Comparative | 90 + 25 | 40(28)*⁵ | 40(37)*⁵ |
| Example 13 | Preparation | | | |
| | Example 1 + | | | |
| | saflufenacil | | | |
| Comparative | Comparative | 90 + 160 | 70(33)*⁵ | 60(28)*⁵ |
| Example 15 | Preparation | | | |
| | Example 1 + | | | |
| | sulfentrazone | | | |

*⁵The Colby expected value is shown in parentheses.

TABLE 5

| | | | Soybean growth | |
|---|---|---|---|---|
| | | Amount of | inhibition rate (%) | |
| | | active | Day 13 | Day 26 |
| | | component | after | after |
| | | (g/ha) | treatment | treatment |
| Comparative | Preparation | 180 | 15 | 10 |
| Example 2 | Example 1 | | | |
| | (microencapsulated | | | |
| | pyroxasulfone) | | | |
| Comparative | Comparative | 180 | 15 | 10 |
| Example 4 | Preparation | | | |
| | Example 1 | | | |
| | (pyroxasulfone) | | | |
| Comparative | Saflufenacil | 50 | 30 | 30 |
| Example 8 | | | | |
| Comparative | Sulfentrazone | 320 | 18 | 15 |
| Example 10 | | | | |
| Example 4 | Preparation | 180 + 50 | 35(41)*⁵ | 25(37)*⁵ |
| | Example 1 + | | | |
| | saflufenacil | | | |
| Example 6 | Preparation | 180 + 320 | 25(30)*⁵ | 15(24)*⁵ |
| | Example 1 + | | | |
| | sulfentrazone | | | |
| Comparative | Comparative | 180 + 50 | 45(41)*⁵ | 40(37)*⁵ |
| Example 14 | Preparation | | | |
| | Example 1 + | | | |
| | saflufenacil | | | |
| Comparative | Comparative | 180 + 320 | 65(30)*⁵ | 60(24)*⁵ |
| Example 16 | Preparation | | | |
| | Example 1 + | | | |
| | sulfentrazone | | | |

*⁵The Colby expected value is shown in parentheses.

1. A weed control method, comprising a soil treatment step of performing a soil treatment on farmland with an agrochemical composition for soil treatment, which comprises pyroxasulfone, and with a protoporphyrinogen oxidase inhibitor, simultaneously or sequentially,
wherein
the agrochemical composition for soil treatment further comprises a masking substance that masks the pyroxasulfone, and
the pyroxasulfone is microencapsulated in or coated with the masking substance.

2. The method according to claim 1, wherein the protoporphyrinogen oxidase inhibitor is selected from the group consisting of saflufenacil, sulfentrazone, flumioxazin, flumiclorac-pentyl, fluthiacet-methyl, lactofen, fomesafen, acifluorfen and salts thereof, bifenox, chlomethoxyfen, oxyfluorfen, halosafen, cinidon-ethyl, carfentrazone-ethyl, azafenidin, benzfendizone, butafenacil, tiafenacil, pyraflufen-ethyl, fluazolate, thidiazimin, oxadiazon, oxadiargyl, chlorphthalim, pentoxazone, pyraclonil, flufenpyr-ethyl, and profluazol.

3. The method according to claim 1, wherein the protoporphyrinogen oxidase inhibitor is selected from the group consisting of saflufenacil, sulfentrazone, and flumioxazin.

4. The method according to claim 1, wherein crystal particles of the pyroxasulfone are directly coated with the masking substance.

5. The method according to claim 1, wherein the pyroxasulfone is enclosed and microencapsulated in a wall material composed of the masking substance.

6. The method according to claim 1, wherein the agrochemical composition for soil treatment has an average particle size of 0.1 to 150 μm.

7. The method according to claim 1, wherein the content ratio of the masking substance is 0.1 to 50 parts by mass with respect to 1 part by mass of pyroxasulfone.

8. The method according to claim 1, wherein the masking substance is selected from the group consisting of polyureas, polyurethanes, polyamides, polyesters, ethyl cellulose, poly(meth)acrylate-based copolymers, carnauba wax, montanic acid ester waxes, hardened oils and fats, polylactic acids, gelatin, cross-linked melamine, polystyrenes, polystyrene-based copolymers, waxes, yeast cell walls, alginates, polyglycolic acids, polyethylene glycol-based copolymers, and shellac.

9. The method according to claim 1, further comprising performing a soil treatment with an agrochemical active component other than the pyroxasulfone and the protoporphyrinogen oxidase inhibitor, simultaneously or sequentially with the agrochemical composition for soil treatment.

10. The method according to claim 1, wherein the agrochemical composition for soil treatment has a dosage form of a dust, a granule, a wettable powder, a water-dispersible granule, an aqueous suspension formulation, or an oily suspension formulation.

11. The method according to claim 1, wherein the soil treatment step is performed before sprouting of a cultivated crop.

12. The method according to claim 11, wherein the cultivated crop is a bean plant.

13. The method according to claim 12, wherein the bean plant is soybean (Glycine max), peanut (Arachis hypogaea), azuki bean (Vigna angularis), common bean (Phaseolus vulgaris), or black-eyed pea (Vigna unguiculata).

14. A mixed agrochemical composition for soil treatment, comprising:
an agrochemical composition for soil treatment, which comprises pyroxasulfone; and
a protoporphyrinogen oxidase inhibitor,
wherein
the agrochemical composition for soil treatment further comprises a masking substance that masks the pyroxasulfone, and
the pyroxasulfone is microencapsulated in or coated with the masking substance.

15. The mixed agrochemical composition for soil treatment according to claim 14, further comprising an agrochemical active component other than the pyroxasulfone and the protoporphyrinogen oxidase inhibitor.
